(19) United States
(12) Patent Application Publication
(10) Pub. No.: US 2024/0289854 A1
(43) Pub. Date: Aug. 29, 2024

(54) PAGE EVALUATION SYSTEM, PAGE EVALUATION METHOD, AND COMPUTER PROGRAM

(71) Applicant: SHIRUSHI Inc., Tokyo (JP)

(72) Inventors: Yoshiro SHIMODA, Tokyo (JP); Takuro Yamazaki, Tokyo (JP)

(21) Appl. No.: 18/524,019

(22) Filed: Nov. 30, 2023

(30) Foreign Application Priority Data
Feb. 24, 2023 (JP) 2023-027062

(51) Int. Cl. G06Q 30/0601; G06Q 30/0241

(52) U.S. Cl. CPC G06Q 30/0601; G06Q 30/0277

(57) ABSTRACT

A page evaluation system that extracts an evaluation target page related to a target product to be sold on a mall-type shopping site from the mall-type shopping site and analyzes the evaluation target page, the page evaluation system including: a page information acquisition unit that acquires information of the evaluation target page; a storage unit that stores a plurality of evaluation items extracted from information displayed on the evaluation target page and allocation points for the evaluation items in association with each other; and an evaluation unit that extracts a plurality of evaluation items from information of the evaluation target page, refers to the storage unit, and evaluates the evaluation target page by calculating the allocation point for at least the evaluation item extracted.

### BACKGROUND

### Technical Field

The present invention relates to a page evaluation system, a page evaluation method, and a computer program.

### Related Art

A mall-type shopping site is known where a large number of sellers sell various products under the same domain on the Internet. An administrator of the mall-type shopping site integrally manages, for example, product pages, sales, and the like of the sellers. Therefore, the sellers can sell products on the mall-type shopping site by transmitting predetermined information on exhibited products to the administrator.

On the other hand, in order to generate the product page on which a purchase examiner purchases the exhibited product in the mall-type shopping site, it is necessary to prepare and transmit various information satisfying requirements to the administrator, and it is troublesome to check whether the product page is in an appropriate state. In addition, since the product page and a search result page in the mall-type shopping site are generated by the mall-type shopping site side, a page convenient for the seller is not necessarily browsed by the purchase examiner. In particular, each page includes another company advertisement posted on the mall-type shopping site, and a review for the seller or the product submitted to the mall-type shopping site, and the like, and thus the seller needs to check the product page generated by the mall-type shopping site.

In this regard, JP 2009-301240 A describes a device that displays a degree of correspondence to authentication criteria such as universal design for web content. JP 2003-271779 A describes an evaluation support method of reading a web page, comparing, with evaluation criteria, items such as whether a size of a file forming the web page is not too large, whether a code such as a model dependent character and a half-width katakana is not used in the file, whether moving display such as blink and scroll is not frequently used, and whether a display color is appropriate, and transmitting advice information indicating advice. JP 2002-189917 A describes an apparatus that evaluates quality of display information of each of a plurality of information distribution means on the basis of a format description of display information acquired by an information acquisition means, and outputs an evaluation result to a network.

However, none of JP 2009-301240 A, JP 2003-271779 A, and JP 2002-189917 A discloses a technique for evaluating a page generated in a mall-type shopping site operated by another company.

### SUMMARY

### Technical Problem

An object of the present invention is to appropriately evaluate effectiveness of a page generated by a mall-type shopping site and browsed by a purchase examiner.

### Solution to Problem

In order to achieve the above object, a page evaluation system according to one aspect of the present invention is a page evaluation system that extracts an evaluation target page related to a target product to be sold on a mall-type shopping site from the mall-type shopping site and analyzes the evaluation target page, the page evaluation system including: a page information acquisition unit that acquires information of the evaluation target page; a storage unit that stores a plurality of evaluation items extracted from information displayed on the evaluation target page and allocation points for the evaluation items in association with each other; and an evaluation unit that extracts a plurality of evaluation items from information of the evaluation target page, refers to the storage unit, and evaluates the evaluation target page by calculating the allocation point for at least the evaluation item extracted.

The storage unit may store identification information of an advertisement related to the target product in association with the target product, and the evaluation unit may specify identification information of an advertisement displayed on the evaluation target page, and may vary evaluation of the evaluation target page between when the advertisement displayed on the evaluation target page is the advertisement related to the target product and when the advertisement is not the advertisement related to the target product.

The storage unit may store a seller of the target product and identification information of an advertisement associated with the seller in association with each other, and the evaluation unit may specify identification information of an advertisement displayed on the evaluation target page, and may increase evaluation of the evaluation target page when the advertisement displayed on the evaluation target page is an advertisement associated with the seller.

The storage unit may store the target product and identification information of a brand associated with the target product in association with each other, the storage unit may store the brand and identification information of an advertisement associated with the brand in association with each other, and the evaluation unit may specify identification information of an advertisement displayed on the evaluation target page, and may increase evaluation of the evaluation target page when the advertisement displayed on the evaluation target page is an advertisement associated with the brand by referring to the storage unit.

The page evaluation system may further include a KPI selection receiving unit that receives selection of a KPI to be used for evaluation of the evaluation target page, the storage unit may store the KPI and an allocation point of each evaluation item included in the evaluation target page in association with each other, the storage unit may store different allocation points for the evaluation items for each KPI, and the evaluation unit may refer to the storage unit, and may evaluate the evaluation target page by calculating the allocation point for each evaluation item on the basis of the KPI received via the KPI selection receiving unit.

The page evaluation system may further include an evaluation target receiving unit that receives a keyword as an evaluation target in the mall-type shopping site, the page information acquisition unit may acquire a search result page displayed on the mall-type shopping site when an inside of the mall-type shopping site is searched with the keyword, and the evaluation unit may evaluate the search result page as the evaluation target page.

In order to achieve the above object, a page evaluation method according to another aspect of the present invention is a page evaluation method for extracting an evaluation target page related to a target product to be sold on a mall-type shopping site from the mall-type shopping site and analyzing the evaluation target page, the method including, by a computer executing: a page information acquisition step of acquiring information of the evaluation target page; an extraction step of extracting a plurality of evaluation items from the information of the evaluation target page; and an evaluation step of evaluating the evaluation target page by referring to a storage unit that stores a plurality of evaluation items extracted from information displayed on the evaluation target page and allocation points for the evaluation items in association with each other, and by calculating the allocation point for at least the evaluation item extracted.

In order to achieve the above object, a computer program according to still another aspect of the present invention is a computer program for extracting an evaluation target page related to a target product to be sold on a mall-type shopping site from the mall-type shopping site and analyzing the evaluation target page, the computer program causing a computer to execute: a page information acquisition command of acquiring information of the evaluation target page; an extraction command of extracting a plurality of evaluation items from the information of the evaluation target page; and an evaluation command of evaluating the evaluation target page by referring to a storage unit that stores a plurality of evaluation items extracted from information displayed on the evaluation target page and allocation points for the evaluation items in association with each other, and by calculating the allocation point for at least the evaluation item extracted.

Note that the computer program can be provided by being stored in various data readable recording media, or can be provided in a downloadable manner via a network such as the Internet.

### Advantageous Effects of the Invention

According to the present invention, it is possible to appropriately evaluate the effectiveness of the page generated by the mall-type shopping site and browsed by the purchase examiner.

### BRIEF DESCRIPTION OF DRAWINGS

FIG. 1 is a functional block diagram illustrating a configuration and a function of a page evaluation system according to a first embodiment of the present invention;

FIG. 2 is an example of a product page evaluated by the page evaluation system;

FIG. 3 is a diagram illustrating an example of a product page evaluation table stored in a point allocation information storage unit included in the page evaluation system;

FIG. 4A is a diagram illustrating an example of a seller-product table stored in a seller information storage unit included in the page evaluation system;

FIG. 4B is a diagram illustrating an example of a seller-brand table stored in the seller information storage unit included in the page evaluation system;

FIG. 4C is a diagram illustrating an example of a product-brand table stored in a product information storage unit included in the page evaluation system;

FIG. 4D is a diagram illustrating an example of a product-advertisement table stored in an advertisement information storage unit included in the page evaluation system;

FIG. 4E is a diagram illustrating an example of a brand-advertisement table stored in the advertisement information storage unit included in the page evaluation system;

FIG. 5 is a processing flow illustrating an example of a flow of analysis by the page evaluation system;

FIG. 6 is an example of a search result page evaluated by the page evaluation system; and

FIG. 7 is a diagram illustrating an example of a search result page evaluation table stored in the point allocation information storage unit included in the page evaluation system according to a second embodiment of the present invention.

### DETAILED DESCRIPTION

### Page Evaluation System (1)

### Overview

Hereinafter, a page evaluation system according to an embodiment of the present invention will be described with reference to the drawings.

The page evaluation system according to the present embodiment acquires information on a page displayed on a mall-type shopping site, performs analysis processing, and outputs an evaluation result. The mall-type shopping site is, for example, Amazon (registered trademark), but is not limited thereto, and may be an appropriate mall-type shopping site where a large number of sellers sell various products under the same domain on the Internet. The page evaluation system is a system that can be used by a retail seller and a wholesaler in addition to a manufacturer who sells the products on the mall-type shopping site. In the following description, such a user may be collectively referred to as a user of the present system.

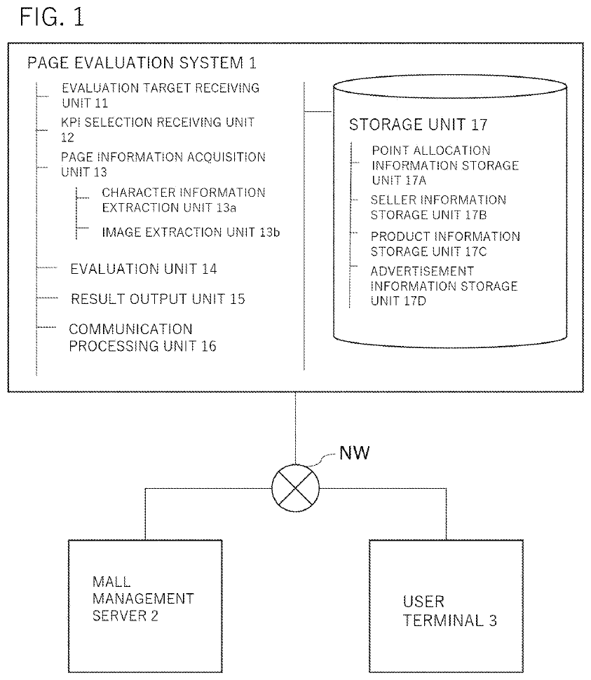

As illustrated in FIG. 1, a page evaluation system 1 is communicably connected to a mall management server 2 and a user terminal 3 via a network NW. The mall management server 2 is a server that manages the mall-type shopping site. The mall management server 2 receives, for example, selling of a plurality of products from a plurality of sellers. The mall management server 2 receives a keyword, product identification information, or the like input via the user terminal 3, and displays a search result page searched by the keyword on the user terminal 3. In addition, the mall management server 2 generates and manages a product page of a product to be sold, and displays the product page, according to an operation from a terminal of a purchase examiner, on the terminal.

The user terminal 3 is a terminal used by a seller who sells the products on the mall-type shopping site. The seller is, for example, the retail seller, or the manufacturer or the wholesaler that sells the products to the seller. The user terminal 3 receives and displays the evaluation result by the page evaluation system 1.

The page evaluation system 1 may be realized by executing a predetermined computer program in, for example, a personal computer, a tablet terminal, a smartphone, or the like, and a part or all of functions may be realized by a cloud computer. In addition, the page evaluation system 1 may include a plurality of hardware configurations.

The page evaluation system 1 is implemented by, for example, a server equipped with an arithmetic unit such as a central processing unit (CPU), a computer program executed by the CPU, an internal memory such as a random access memory (RAM) or a read only memory (ROM), and the like. Thus, the page evaluation system 1 constitutes a functional block mainly including an evaluation target receiving unit 11, a KPI selection receiving unit 12, a page information acquisition unit 13, an evaluation unit 14, a result output unit 15, a communication processing unit 16, and a storage unit 17.

The evaluation target receiving unit 11 is a functional unit that acquires information on an evaluation target from the user terminal 3 via the communication processing unit 16. The information on the evaluation target is, for example, text data, more specifically, a search keyword. Further, the information on the evaluation target may be the product identification information.

The KPI selection receiving unit 12 is a functional unit that receives selection of a key performance indicator (KPI) to be used for evaluation of an evaluation target page. The user selects a KPI from, for example, sales or a brand image, and transmits the KPI via the user terminal 3.

The page information acquisition unit 13 is a functional unit that acquires information on the evaluation target page displayed by the mall management server 2 on the terminal of the purchase examiner. The evaluation target page is, for example, the product page generated for each product.

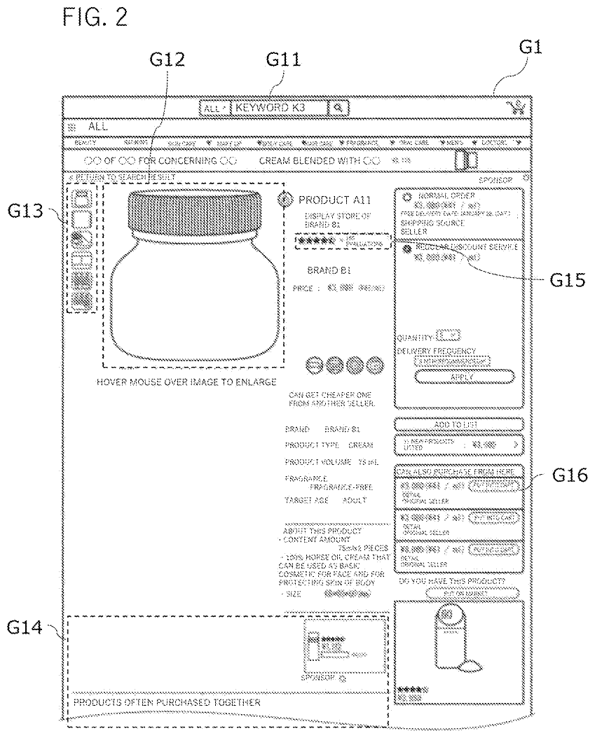

FIG. 2 is an example of a product page G1 displayed on the user terminal 3. The product page G1 displays a keyword input area G11, a main image area G12 for displaying a main image of the product, a sub-image area G13 in which images displayed in the main image area according to the selection are listed, an advertisement area G14, a display area G15 of a review to the seller, a resale status display area G16, and the like.

The page information acquisition unit 13 includes a character information extraction unit 13a that acquires character information of the evaluation target page and an image extraction unit 13b included in the evaluation target page. The character information extraction unit 13a acquires, for example, at least information displayed as character information on the evaluation target page from source code. The image extraction unit 13b may acquire a description indicating a display image from the source code, or may acquire image data indicated by the display image. Further, the page information acquisition unit 13 may extract information by acquiring the image data displayed on the evaluation target page and performing image analysis on the image data. Furthermore, the page information acquisition unit 13 specifies identification information of an advertisement displayed on the evaluation target page on the basis of the information extracted from the evaluation target page.

The evaluation unit 14 is a functional unit that evaluates the evaluation target page on the basis of the information acquired by the page information acquisition unit 13. The evaluation unit 14 extracts a plurality of evaluation items from the information acquired by the page information acquisition unit 13 and evaluates the content for each evaluation item. The evaluation unit 14 calculates a predetermined evaluation value for the evaluation target page, for example.

The evaluation unit 14 extracts the evaluation item by, for example, searching for a predetermined word from the source code of the evaluation target page. The evaluation unit 14 extracts as the evaluation items, for example, the number and size of a sub-image, evaluation for the seller, evaluation for the product, information on the displayed advertisement area, available shipping mode, resale status, display content of Q & A, and the like. The evaluation for the seller and the evaluation for the product may be information divided into predetermined stages and scored, or may be text data posted by a purchaser or the like. The information on the advertisement area may be type, content, and identification information of the advertisement. Further, the information on the advertisement area may be information of a product or a brand advertised in the advertisement. The evaluation unit 14 may extract the identification information of the advertisement with reference to, for example, the source code, and acquire information of the product or the brand associated with the identification information. Furthermore, the evaluation unit 14 may acquire information of the product or the brand by, for example, analyzing an image of the advertisement.

Each evaluation item evaluated by the evaluation unit 14 may include information generated by the mall management server 2 in addition to information transmitted from the seller. For example, the number and size of the sub-image are items evaluated based on the sub-image transmitted by the seller. The evaluation for the seller and the product is generated by the mall management server 2 based on the information received by the mall management server 2 from the purchaser. The information on the advertisement area is generated on the basis of information received by the mall management server 2 from the seller or another seller.

Here, a configuration of the storage unit 17 included in the page evaluation system 1 will be described, and a specific aspect of the evaluation performed by the evaluation unit 14 with reference to the storage unit 17 will be described.

The storage unit 17 mainly includes a point allocation information storage unit 17A, a seller information storage unit 17B, a product information storage unit 17C, and an advertisement information storage unit 17D.

The point allocation information storage unit 17A stores the evaluation items of the evaluation target page and the allocation point of each evaluation item included in the evaluation target page in association with each other.

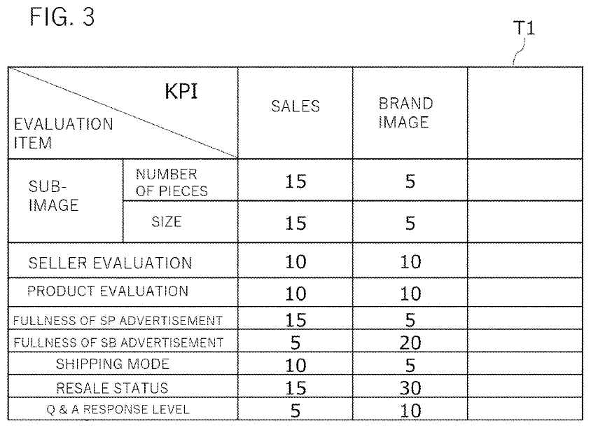

FIG. 3 is a diagram illustrating an example of a product page evaluation table T1 referred to in evaluation of the product page G1. In the product page evaluation table T1, the evaluation items for evaluating the product page G1 and the allocation points are stored in association with each other. The evaluation items include, for example, the number and size of the sub-image displayed on the product page G1, the evaluation for the seller, the evaluation for the product, fullness of the advertisement area, the shipping mode, the resale status, and response level to Q & A, and the like.

The evaluation unit 14 refers to the product page evaluation table T1 and calculates the allocation point for each evaluation item to evaluate the evaluation target page. According to this configuration, by evaluating various evaluation items constituting the product page, it is possible to appropriately evaluate an appeal to the purchase examiner. In addition, since the user can improve the product page to a page with higher appeal on the basis of this evaluation, profit of the user can be increased.

The product page evaluation table T1 stores different allocation points for the evaluation items for each key performance indicator (KPI) for evaluating the evaluation target page. In the figure, the product page evaluation table T1 stores two items of the sales and the brand image as KPIs. In addition, the allocation point for the sub-image when the KPI is the sales is different from the allocation point for the sub-image when the KPI is the brand image. For example, fullness of the sub-image contributes to the sales, but does not greatly affect the brand image. Therefore, the allocation point when the KPI is the sales is higher than the allocation point when the KPI is the brand image. In addition, since the resale status may damage the brand image, the allocation point with respect to the resale status is higher when the KPI is the brand image than when the KPI is the sales. Note that the above point allocation is an example, and the present invention is not limited to such an aspect. Further, in the present embodiment, the point allocation has been described as a point addition method, but may be a point deduction method, and an item in which a point is added and an item in which a point is deducted may be included. Furthermore, there may be content for which a point is added and content for which a point is deducted.

The evaluation unit 14 refers to the product page evaluation table T1 and calculates the allocation point for each evaluation item on the basis of the KPI received via the KPI selection receiving unit 12, to evaluate the evaluation target page. As described above, according to a configuration in which the allocation point is varied for each evaluation item according to the KPI to be evaluated, it is possible to perform evaluation according to a purpose emphasized by the user.

The seller information storage unit 17B is a functional unit that stores information on the seller.

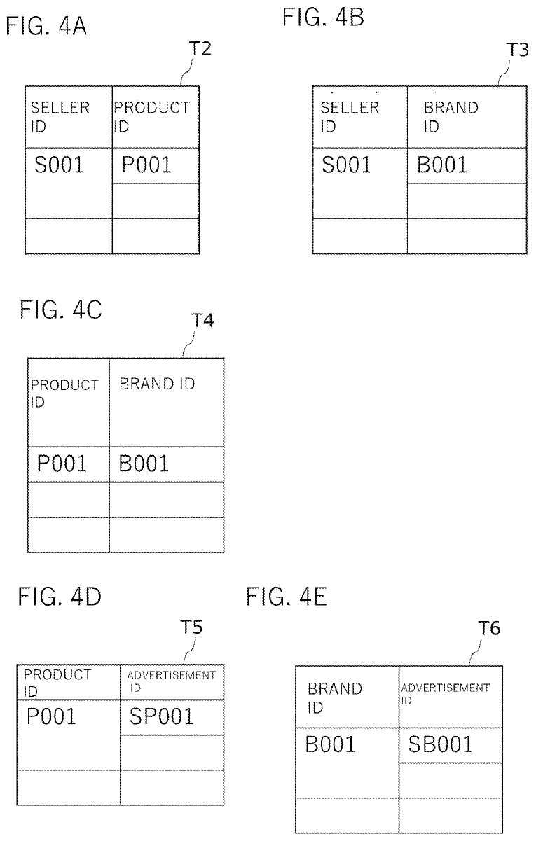

As illustrated in FIG. 4A, the seller information storage unit 17B stores, for example, a seller-product table T2 that stores information of the product to be sold by the seller in association with identification information of the seller. The advertisement associated with the seller is, for example, an advertisement posted by the seller, a cooperative company of the seller, or the like. The seller information storage unit 17B may store the type and content of the advertisement associated with the seller in association with the identification information of the seller. The advertisement refers to, for example, an image, a moving image, a sound, or the like, and is managed by identification information different for each type of the image, the moving image, the sound, or the like.

As illustrated in FIG. 4B, the seller information storage unit 17B may store a seller-brand table T3 that stores a brand associated with the seller in association with the identification information of the seller. The brand associated with the seller is a brand that is positive for the seller when an advertisement of the brand is displayed. This brand may be, for example, a brand under the control or revenue of the seller. The seller may have a plurality of brands.

The product information storage unit 17C is, for example, a functional unit that stores information on the product. As illustrated in FIG. 4C, the product information storage unit 17C stores a product-brand table T4 that stores the product and identification information of the brand associated with the product in association with each other. The brand associated with the product is, for example, a brand to which the product belongs.

The advertisement information storage unit 17D is a functional unit that stores an advertisement related to the product. The advertisement information storage unit 17D stores, for example, information on the advertisement of the product or the brand.

As illustrated in FIG. 4D, the advertisement information storage unit 17D stores, for example, a product-advertisement table T5 that stores identification information of the product and identification information of the advertisement associated with the product in association with each other. The advertisement associated with the product is, for example, a sponsor product advertisement (in the figure and hereinafter, the advertisement is also referred to as “SP advertisement”) that advertises the product.

As illustrated in FIG. 4E, the advertisement information storage unit 17D stores a brand-advertisement table T6 that stores brand identification information and advertisement identification information in association with each other. The advertisement associated with the product is, for example, a sponsor brand advertisement (hereinafter, also referred to as an “SB advertisement”) that advertises the brand. That is, the advertisement associated with the product, the advertisement associated with the seller of the product, the advertisement associated with the brand associated with the product, and the advertisement associated with another product associated with the brand are all examples of the advertisement associated with the product.

The evaluation unit 14 refers to the seller information storage unit 17B and extracts information of the seller of the product in the evaluation target page. The evaluation unit 14 varies evaluation for the evaluation target page according to the information of the seller. The evaluation unit 14 specifies the identification information of the advertisement displayed on the evaluation target page, and varies evaluation of the evaluation target page between when the advertisement displayed on the evaluation target page is an advertisement related to the product mainly sold on the evaluation target page, that is, an advertisement related to the target product and when the advertisement is not the advertisement related to the target product. For example, the evaluation unit 14 increases the evaluation of the evaluation target page when the advertisement is related to the target product as compared with when the advertisement is not related to the target product.

Specifically, for example, the evaluation unit 14 refers to the seller-product table T2 and the product-advertisement table T5, and extracts the identification information of the advertisement associated with the seller of the target product. The evaluation unit 14 specifies the identification information of the advertisement displayed on the evaluation target page and determines whether the advertisement is the advertisement associated with the seller. When the advertisement displayed on the evaluation target page is the advertisement associated with the seller, the evaluation unit 14 increases the evaluation of the evaluation target page. Note that when the advertisement displayed on the evaluation target page is not the advertisement associated with the seller, the evaluation unit 14 may lower the evaluation of the evaluation target page. In addition, the evaluation unit 14 may evaluate the evaluation target page based on a ratio occupied by the advertisement associated with the seller among a plurality of advertisements displayed on the evaluation target page.

Note that in the present embodiment, it has been described that the storage unit 17 stores the seller-product table T2 and the product-advertisement table T5, but database structure is arbitrary, and the storage unit 17 may store, for example, a table that stores the identification information of the seller and the identification information of the advertisement in association with each other. In any aspect, the storage unit 17 stores the identification information of the seller and the identification information of the advertisement in association with each other.

Since the advertisement area of the evaluation target page is occupied by an advertisement of an own product, it is possible to secure an opportunity to purchase the own product to the purchase examiner. In addition, since an advertisement of an own brand is displayed, it is possible to improve the brand image of the own brand held by the purchase examiner. However, when selling the product on the mall-type shopping site, since the advertisement displayed in the advertisement area is managed by the mall management server 2, an advertisement of another company may be displayed. In this regard, even if the seller refers only to product information and advertisement information registered in the mall management server 2, it is not clear what screen the purchase examiner who browses the evaluation target page browses. In this regard, according to the configuration as described above, even when the advertisement is displayed under the control of the mall management server 2, it is possible to appropriately evaluate the appeal to the purchase examiner in the evaluation target page by evaluating an actual page browsed by the purchase examiner.

The evaluation unit 14 may refer to the product-brand table T4 and the brand-advertisement table T6 after referring to the identification information of the target product, and extract the identification information of the advertisement of the brand to which the target product belongs. The evaluation unit 14 may increase the evaluation when an advertisement of a brand associated with the target product or an advertisement of another product associated with the brand is displayed.

The evaluation unit 14 may refer to the product-brand table T4 and the brand-advertisement table T6, and extract the identification information of the advertisement of another product of the brand associated with the target product. The evaluation unit 14 may vary the evaluation between when the advertisement of the target product is displayed and when the advertisement of another product belonging to the same brand as the target product is displayed. In addition, the evaluation unit 14 may determine that the advertisement of the brand that is associated with the seller of the target product and is different from the brand to which the target product belongs is displayed. The evaluation unit 14 may vary the evaluation between the advertisement of the brand to which the target product belongs and the advertisement of the brand to which the target product does not belong among the brands associated with the seller. Specifically, for example, the evaluation unit 14 may give a higher evaluation when the advertisement of the brand to which the target product belongs is displayed than when the advertisement of the brand to which the target product does not belong is displayed.

The evaluation unit 14 may acquire one evaluation target page a plurality of times and perform evaluation. For example, the evaluation unit 14 may periodically acquire the evaluation target page and perform each evaluation. In this case, the evaluation unit 14 may calculate an average of evaluation values of the evaluation target page obtained through multiple evaluations, or may calculate transition of the evaluation values. In the evaluation target page, different advertisements may be displayed randomly or according to a predetermined condition at the time of loading. Further, the displayed advertisement changes depending on a measure of the seller or a competitor. Furthermore, information such as review of the seller or the product changes sequentially. In this regard, according to the above-described configuration, a status of the advertisement displayed on the evaluation target page can be more accurately evaluated.

The result output unit 15 is a functional unit that outputs a result screen including the evaluation result of the evaluation target page. The result output unit 15 displays a score of the evaluation target page calculated according to the KPI and the allocation point on the user terminal 3. The result output unit 15 may display the evaluation result for each evaluation item or may display a comprehensive evaluation obtained by integrating a plurality of evaluation results. The result output unit 15 may display advice for increasing the evaluation on the user terminal 3.

The communication processing unit 16 is a functional unit that performs transmission and reception of the information via the network NW such as the Internet.

With the communication processing unit 16, the page evaluation system 1 can access the mall-type shopping site to extract the information and transmit the information to the user terminal 3.

The product page displays a name of the product, an explanatory image of the product, the advertisement of another product related to the product, the review of the product, the information of the seller set as a prescribed value, and the like. However, display of the product page is created and edited by the mall management server 2, and is changed as needed by selling by a new seller or posting of review by the purchaser. In addition, the advertisement of another product is also changed as needed due to entry of a new advertiser, input of advertising expenses of an existing advertiser, change of an image presented by the advertiser, or the like. Moreover, the product page is a screen that the purchase examiner always browses when making a decision to purchase, and thus has high importance in terms of marketing. Therefore, according to a configuration of acquiring and evaluating the information of the product page by the page information acquisition unit 13, effectiveness of the page browsed by the purchase examiner can be appropriately evaluated even when selling the product on the mall-type shopping site operated and managed by another company.

### Flow of Processing

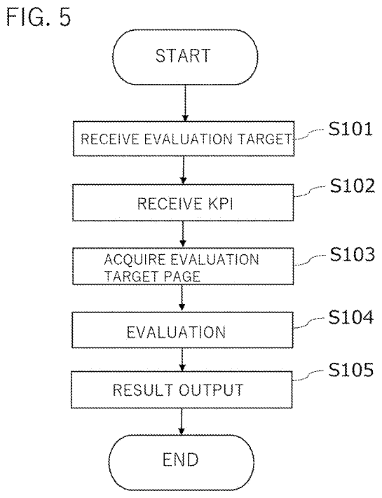

FIG. 5 is a flowchart illustrating an example of a flow of processing executed by the page evaluation system 1.

First, the evaluation target receiving unit 11 receives the keyword, the identification information, or the like as the evaluation target via the user terminal 3 (step S101). The KPI selection receiving unit 12 receives selection of a KPI to be emphasized via the user terminal 3 (step S102).

Next, the page information acquisition unit 13 acquires information of the evaluation target page (step S103). Next, the evaluation unit 14 evaluates the evaluation target page on the basis of the KPI received via the KPI selection receiving unit 12 (step S104). Next, the result output unit 15 outputs an evaluation result screen to the user terminal 3 (step S105).

Note that the above-described flowchart is an example, and the processing may be executed in an appropriately different order or simultaneously.

### Page Evaluation System (2)

The page evaluation system 1 according to a second embodiment of the present invention will be described focusing on differences from the first embodiment described above. The page evaluation system 1 described below evaluates a product search result page displayed on a mall-type shopping site acquired by the page information acquisition unit as the evaluation target page. Note that the same components as those of the first embodiment are denoted by the same reference numerals.

The evaluation target receiving unit 11 according to the present embodiment receives the search keyword in the mall shopping site as the evaluation target. Further, the evaluation target receiving unit 11 acquires identification information of the user who intends to receive evaluation by the present system 1. The page information acquisition unit 13 acquires the search result page generated and displayed by the mall management server 2 when searching an inside of the mall-type shopping site with the keyword. The evaluation unit 14 analyzes the search result page and evaluates the appeal to the purchase examiner, and the like.

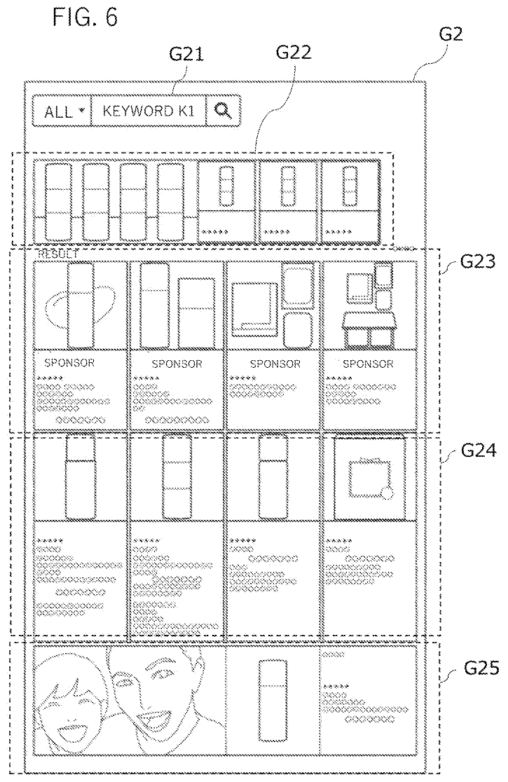

FIG. 6 is an example of a search result page G2 displayed on the user terminal 3. The search result page G2 mainly displays an input area G21 to which a keyword for evaluation is input, an SB advertisement area G22, and an SP advertisement area G23, a search result area G24 in which products extracted by search are listed, a moving image advertisement area G25, and the like.

The evaluation target receiving unit 11 acquires the information of the seller associated with the user. The user and the seller may be the same or different. The evaluation unit 14 acquires the identification information of the product displayed in the search result area G24 of the search result page G2. The evaluation unit 14 refers to the seller-product table T2 and determines whether the product displayed in the search result area G24 is the product of the seller associated with the user. The evaluation unit 14 increases the evaluation when the product of the seller associated with the user is displayed in the search result area G24. Further, the evaluation unit 14 may lower the evaluation when a product other than the seller is displayed in the search result area G24. The evaluation unit 14 may calculate the evaluation value based on a ratio occupied by the seller among the products displayed in the search result area G24. Furthermore, the evaluation unit 14 may calculate the evaluation value on the basis of rank of the displayed product. According to such a configuration, it is possible to evaluate effectiveness of search engine optimization (SEO) measure of the seller.

The evaluation unit 14 may perform evaluation according to the content or type of the displayed advertisement. For example, the evaluation may be performed according to the presence or absence of the moving image or the presence or absence of a custom image in the SB advertisement.

Further, the evaluation unit 14 extracts the identification information of the advertisement displayed on the search result page G2. The evaluation unit 14 refers to the product-advertisement table T5 and extracts the identification information of the advertisement of the seller associated with the user. The evaluation unit 14 determines whether the advertisement displayed on the search result page G2 is the advertisement of the seller associated with the user, and adds a point to the evaluation value when the advertisement of the seller is displayed. Further, the evaluation unit 14 may reduce the evaluation value when the product other than the seller is displayed. Furthermore, the evaluation unit 14 may calculate the evaluation value based on a ratio occupied by the advertisement of the seller among advertisements displayed on the search result page G2. The evaluation unit 14 may vary a contribution rate to the evaluation value for a plurality of advertisement areas displayed on the search result page G2, that is, the SB advertisement area G22, the SP advertisement area G23, and the moving image advertisement area G25. Further, the evaluation unit 14 may vary the contribution rate to the evaluation value depending on a mode of the advertisement. For example, since a moving image advertisement has higher appeal than a still image advertisement, a contribution rate of the moving image advertisement may be made larger than a contribution rate of the still image advertisement.

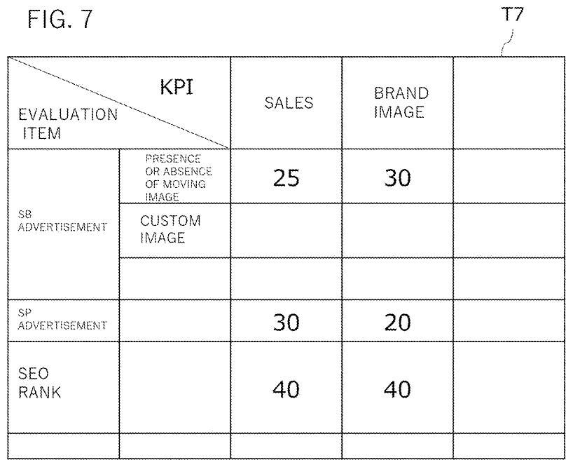

FIG. 7 is a diagram illustrating a search result page evaluation table T7 stored in the point allocation information storage unit 17A included in the page evaluation system 1. In the figure, the search result page evaluation table T7 stores the evaluation items and the allocation points for evaluating the evaluation target page. The evaluation item includes, for example, an index related to quantity and quality of the SB advertisement and the SP advertisement. Further, the evaluation item includes a display rank (in the figure and hereinafter, also referred to as an “SEO rank”.) of the search result.

In the search result page evaluation table T7, different allocation points are stored for the evaluation items for each KPI. That is, for example, the allocation point to the SB advertisement in when the KPI is the sales is different from the allocation point to the SB advertisement when the KPI is the brand image. The evaluation for the SP advertisement has a higher contribution to the sales than the SB advertisement that aims to improve brand recognition. Therefore, when the sales is emphasized as the KPI, the allocation point for the SP advertisement is higher than the allocation point for the SB advertisement. Conversely, when the brand image is emphasized as the KPI, the allocation point for the SB advertisement that aims to improve brand image recognition is higher than the allocation point for the SP advertisement.

Even with the configuration as described above, even when the advertisement is displayed under the control of the mall management server 2, it is possible to appropriately evaluate the appeal to the purchase examiner in the evaluation target page by evaluating an actual page browsed by the purchase examiner.

According to the page evaluation system according to the embodiment of the present invention described above, it is possible to evaluate effectiveness of a page related to a selling product displayed on the mall-type shopping site.

Note that in the page evaluation system according to the present embodiment described above, a functional configuration of each terminal or device is an example, and the functional unit described in the present example can be included in a terminal or device different from the present example.

What is claimed is:

1. A page evaluation system that extracts an evaluation target page related to a target product to be sold on a mall-type shopping site from the mall-type shopping site and analyzes the evaluation target page, the page evaluation system comprising:
a page information acquisition unit that acquires information of the evaluation target page;
a storage unit that stores a plurality of evaluation items extracted from information displayed on the evaluation target page and allocation points for the evaluation items in association with each other; and
an evaluation unit that extracts a plurality of evaluation items from information of the evaluation target page, refers to the storage unit, and evaluates the evaluation target page by calculating the allocation point for at least the evaluation item extracted.

2. The page evaluation system according to claim 1, wherein
the storage unit stores identification information of an advertisement related to the target product in association with the target product, and
the evaluation unit specifies identification information of an advertisement displayed on the evaluation target page, and varies evaluation of the evaluation target page between when the advertisement displayed on the evaluation target page is the advertisement related to the target product and when the advertisement is not the advertisement related to the target product.

3. The page evaluation system according to claim 1, wherein
the storage unit stores a seller of the target product and identification information of an advertisement associated with the seller in association with each other, and
the evaluation unit specifies identification information of an advertisement displayed on the evaluation target page, and increases evaluation of the evaluation target page when the advertisement displayed on the evaluation target page is an advertisement associated with the seller.

4. The page evaluation system according to claim 1, wherein
the storage unit stores the target product and identification information of a brand associated with the target product in association with each other,
the storage unit stores the brand and identification information of an advertisement associated with the brand in association with each other, and
the evaluation unit specifies identification information of an advertisement displayed on the evaluation target page, and increases evaluation of the evaluation target page when the advertisement displayed on the evaluation target page is an advertisement associated with the brand by referring to the storage unit.

5. The page evaluation system according to claim 1, further comprising
a KPI selection receiving unit that receives selection of a KPI to be used for evaluation of the evaluation target page, wherein
the storage unit stores the KPI and an allocation point of each evaluation item included in the evaluation target page in association with each other,
the storage unit stores different allocation points for the evaluation items for each KPI, and
the evaluation unit refers to the storage unit, and evaluates the evaluation target page by calculating the allocation point for each evaluation item on the basis of the KPI received via the KPI selection receiving unit.

6. The page evaluation system according to claim 1, further comprising
an evaluation target receiving unit that receives a keyword as an evaluation target in the mall-type shopping site, wherein
the page information acquisition unit acquires a search result page displayed on the mall-type shopping site when an inside of the mall-type shopping site is searched with the keyword, and
the evaluation unit evaluates the search result page as the evaluation target page.

7. A page evaluation method for extracting an evaluation target page related to a target product to be sold on a mall-type shopping site from the mall-type shopping site and analyzing the evaluation target page, the method comprising, by a computer, executing:
a page information acquisition step of acquiring information of the evaluation target page;
an extraction step of extracting a plurality of evaluation items from the information of the evaluation target page; and
an evaluation step of evaluating the evaluation target page by referring to a storage unit that stores a plurality of evaluation items extracted from information displayed on the evaluation target page and allocation points for the evaluation items in association with each other, and by calculating the allocation point for at least the evaluation item extracted.

8. A computer program for extracting an evaluation target page related to a target product to be sold on a mall-type shopping site from the mall-type shopping site and analyzing the evaluation target page, the computer program causing a computer to execute:
a page information acquisition command of acquiring information of the evaluation target page;
an extraction command of extracting a plurality of evaluation items from the information of the evaluation target page; and
an evaluation command of evaluating the evaluation target page by referring to a storage unit that stores a plurality of evaluation items extracted from information displayed on the evaluation target page and allocation points for the evaluation items in association with each other, and by calculating the allocation point for at least the evaluation item extracted.
